(19) United States
(12) Patent Application Publication
(10) Pub. No.: US 2006/0233412 A1
(43) Pub. Date: Oct. 19, 2006

(54) Microphone apparatus for a hearing aid

(75) Inventors: Torsten Niederdrank, Erlangen (DE); Joseph Sauer, Strullendorf (DE); Markus Trautner, Nurnberg (DE); Christian Weistenhofer, Bubenreuth (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS AUDIOLOGISCHE TECHNIK GmbH

(21) Appl. No.: 11/402,325

(22) Filed: Apr. 11, 2006

Related U.S. Application Data
(60) Provisional application No. 60/671,343, filed on Apr. 14, 2005.

(30) Foreign Application Priority Data
Apr. 14, 2005 (DE) 10 2005 017 357.8

(51) Int. Cl. H04R 17/02

(52) U.S. Cl. 381/369

(57) ABSTRACT

Hearing aids are to be further miniaturized and simplified in terms of their manufacture. Provision is made for this purpose for the microphone facility for a hearing aid to be manufactured from at least one silicon microphone, said silicon microphone being attached to a MID plastic carrier (Molded Interconnected Device). This plastic carrier then features the double functionality of a microphone housing segment and a printed circuit board.

### CROSS REFERENCE TO RELATED APPLICATIONS

This application claims priority to the German Application No. 10 2005 017 357.8, filed Apr. 14, 2005, and to the U.S. Provisional Application No. 60/671,343, filed Apr. 14, 2005 which are incorporated by reference herein in their entirety.

### FIELD OF INVENTION

The present invention relates to a microphone apparatus for a hearing aid with at least one silicon microphone. In particular, the present invention relates to a housing or a carrier of the at least one silicon microphone.

### BACKGROUND OF INVENTION

Microphones require an acoustically sealed housing with one or a number of defined sound inlets and electrical contacts. The acoustic converter typically operates according to the principle of the capacitor microphone and correspondingly emits a weak, interference-prone signal. Signal postprocessing and amplification is thus generally still necessary within the housing. The accommodation of the acoustic converter and the electronics in a housing nevertheless restricts the microphone from being further miniaturized.

### SUMMARY OF INVENTION

Silicon microphones are advantageous in that the converter and the signal processing consist in each instance of a chip and thus can be accommodated together on a circuit board. This primarily facilitates the assembly of the microphone. Silicon microphones nevertheless stand out in terms of the minimal space they occupy. A silicon microphone of this type is described for instance in the publication DE 38 07 251 A1.

The publication EP 1 317 163 A2 discloses a hearing aid with a housing, in which a receiver unit and a microphone unit are accommodated. Electronic devices of the microphone unit can be soldered onto a carrier plate, which is configured as a molded part with an integrated pattern structure (Molded Interconnect Devices; MID). The molded part can thus be a part of the housing of the microphone unit. In addition, it is proposed to configure at least parts of the housing as spatially injection-molded circuit carriers (Molded Interconnect Devices; MID).

An object of the present invention is thus to further miniaturize hearing aid microphones together with the housing.

In accordance with the invention, this object is achieved by a microphone apparatus for a hearing aid with at least one silicon microphone and an MID plastic carrier (Molded Interconnected Device), which is at least part of a housing of the at least one silicon microphone and which serves as a printed circuit board for contact with the at least one silicon microphone.

The knowledge underlying the invention is that dimensions of the microphone can be reduced by designing the circuit board of the silicon microphone as a housing component.

The use of an MID carrier as a circuit board and housing component additionally reduces the number of mechanical components. The assembly of the microphone is furthermore essentially simplified by adhering the MID carrier to a housing hood. The external dimensions of the component with the silicon microphone and the MID plastic carrier can thus be designed smaller than with conventional silicon micro phones.

A connecting piece for the sound entry is preferably formed on the MID plastic carrier. An adherence of the microphone inlet connecting piece is thereby no longer necessary in a separate production step. This is thus particularly advantageous since highest quality demands are imposed on adhesions in hearing aids.

A signal processing facility for the silicon microphone is also favorably arranged on and in contact with the MID plastic carrier. The signal processing is thus arranged correspondingly close to the microphone.

In a special embodiment, the housing of the silicon microphone or a part thereof is formed in one piece with a hearing aid shell, which is manufactured using MID technology. The hearing aid shell thus features the additional functionality of a circuit board.

The housing of the silicon microphone can consist partially of metal. The necessary electromagnetic shielding is realized through said housing.

The MID plastic carrier can also be metallized at least on one part of its surface. The required electrical and/or magnetic shielding can hereby be optimized.

In a special embodiment it is possible that the silicon microphone in the SMD technology is in direct contact with the MID plastic carrier. A higher level of automation can thus be achieved.

To ensure a directional microphone, a number of silicon microphones can be combined into a microphone array, which is adjusted to shape of the hearing aid. The minimal dimensions of silicon microphones allow the available space of the hearing aids to be better utilized, in which namely the surface contour of primarily a microphone array extending over an area is designed according to the shape of the hearing aid.

### BRIEF DESCRIPTION OF THE DRAWINGS

The present invention is now described in more detail below with reference to the appended drawings, in which;

FIG. 1 shows a microphone apparatus according to the invention with a silicon microphone on a MID plastic carrier;

FIG. 2 shows the microphone apparatus of FIG. 1 with a housing upper part and

FIG. 3 shows the microphone apparatus of FIG. 2 from the underside.

### DETAILED DESCRIPTION OF INVENTION

The exemplary embodiment illustrated in more detail below represents a preferred embodiment of the present invention.

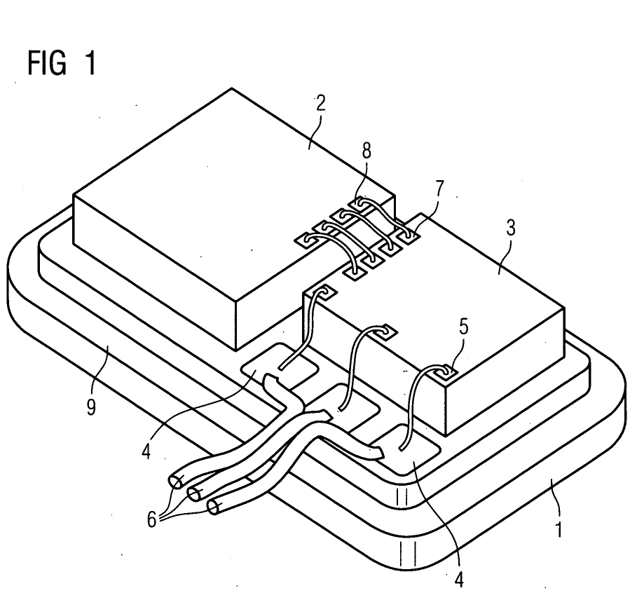

According to the embodiment of FIG. 1, the circuit board 1 for the silicon microphone 2 and the preamplifier 3 is manufactured using MID technology (Molded Interconnected Device). Both the silicon microphone 2 and also the preamplifier 3 are designed as integrated circuitry, i.e. both acoustic converters as well as electronics are installed on the MID plastic carrier 1.

In the present example, on the surface of the MID plastic carrier 1, three contact points 4 are attached to the MID plastic carrier 1. The output connections 5 of the preamplifier 3 are bonded to these contact points 4. Connection wires 6 are soldered to the contact points 4 in order to guide the contacts outwards. Furthermore, the input contacts 7 of the preamplifier 3 are bonded to the output contacts 8 of the silicon microphone 2.

According to an alternative embodiment which is not displayed in a drawing, the contacts of the silicon microphone and of the preamplifier can be provided on the underside of the respectively integrated circuit, so that the two integrated circuits with SMD technology can be soldered onto the MID plastic carrier. This presumes that the corresponding connections and contact points are attached to corresponding locations on the MID plastic carrier.

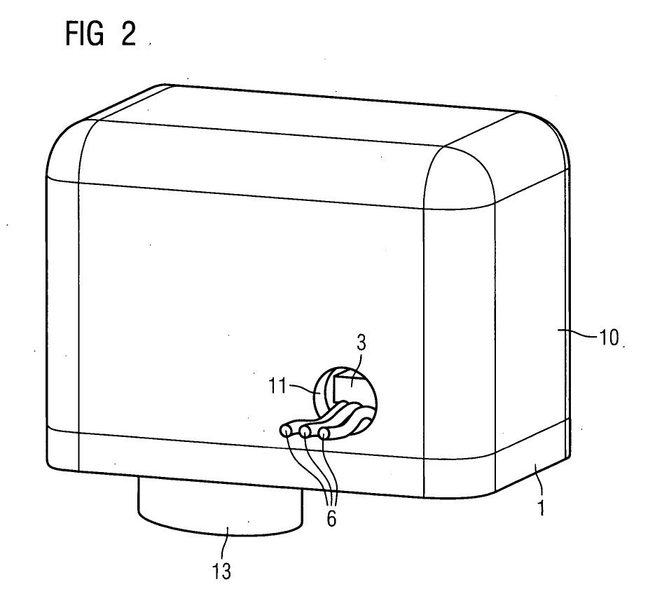

The plate-like MID plastic carrier 1 which serves as a circuit board features a step 9 which runs around the circumference. A housing upper part 10 can be attached to this step 9 according to FIG. 2. The MID plastic carrier 1 as the housing lower part thus forms an essentially closed microphone housing with the housing upper part 10.

The housing upper part 10 is preferably made from metal for shielding purposes. A cut-out 11 is located in one of its side walls, by means of said cut-out the connection wires 6 are guided outwards.

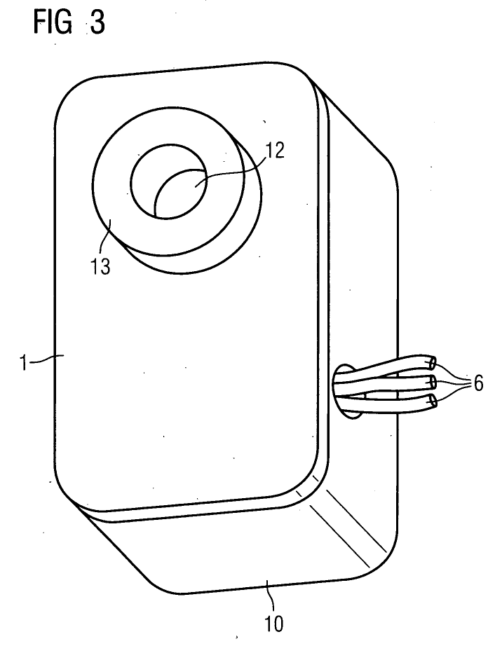

A sound entry port 12 is located on the underside of the MID plastic carrier 1 directly below the silicon microphone 2. This can be clearly identified in the underside view in FIG. 3. The sound entry port 12 is surrounded by a tubular connecting piece, by means of which the incoming sound is better directed to the sound entry port 12. For this purpose, the interior of the connecting piece 13 can be configured to be conical.

The MID technology allows the connecting piece 13 to be implemented in one piece with the MID plastic carrier 1, i.e. the connect ion circuit board for the silicon microphone 2 and the preamplifier 2. This represents a significant advantage compared with the prior art. If, according to the prior art, a conventional circuit board is built into a microphone housing with an integrated connecting piece, a correspondingly large space must be provided for the circuit board, if the circuit board is not simultaneously used as a housing component.

If, in contrast, a conventional circuit board is used as a housing component, an acoustic connecting piece 13 must be adhered to the conventional circuit board for improved sound transmission. This signifies the operation of several components and the additional production step of adherence.

These disadvantageous are avoided by the MID plastic carrier 1 according to the invention and the advantages of the two above-illustrated designs are combined with each other. On the one hand, the circuit board is used as a housing underpart, so that the dimensions of the complete microphone unit can be reduced and on the other hand, the microphone inlet connecting piece 13 is molded directly onto the MID plastic carrier 1, so that a precise adhesive step to be implemented can be obviated.

To improve the electromagnetic compatibility, the MID plastic carrier 1 can be metallized. Likewise, the housing upper part 10 can be molded from a plastic and subsequently metallized, or better, completely made of metal.

According to a further embodiment, a number of silicon microphones including a preamplifer IC are attached to the MID plastic carrier. The possibility exists here that the MID plastic carrier, as mentioned from the outset, is adjusted exactly to the shape of the hearing aid, so that additional space can be spared.

In terms of the available space, it is even more favorable for the hearing aid shell to be manufactured using MID technology, so that the silicon microphones and further electronic components can be in direct contact with the hearing aid housing shell. This not only frees up the space that would b e occupied by the individual circuit board, but also allows the logistical complexity in assembling a hearing aid to be reduced.

1.-8. (canceled)

9. A microphone apparatus for a hearing aid, comprising:
at least one silicon microphone having a microphone housing; and
an MID plastic carrier at least partially integrated into the microphone housing, the MID plastic carried sized and configured as a printed circuit board for establishing a contact with the at least one silicon microphone.

10. The microphone apparatus according to claim 9, further comprising
a stub molded onto the MID plastic carrier, the stub sized and configured for receiving a sound to be processed by the silicon microphone.

11. The microphone apparatus according to claim 9, further comprising a signal processing device for processing signals generated by the silicon microphone, the signal processing device arranged on and in being in contact with the MID plastic carrier.

12. The microphone apparatus according to claim 9, wherein at least part of the microphone housing is forms an integral with a hearing aid jacket, the hearing aid jacket manufactured using MID technology.

13. The microphone apparatus according to claim 9, wherein at least part of the microphone housing is made of metal.

14. The microphone apparatus according claim 9, wherein at least part of a surface of the MID plastic carrier is metallized.

15. The microphone apparatus according to claim 9, wherein the silicon microphone is directly contacted to the MID plastic carrier using SMD technology.

16. The microphone apparatus according to claim 9, comprising a plurality of silicon microphones arranged as a microphone array, the microphone array adapted to a shape of the hearing aid.
